(19) United States
(12) Patent Application Publication
(10) Pub. No.: US 2023/0072819 A1
(43) Pub. Date: Mar. 9, 2023

(54) INTERLOCKING COMPONENTS FOR FORMING A WEAR RESISTANT LAYER

(71) Applicant: DIAMOND INNOVATIONS, INC., Worthington, OH (US)

(72) Inventor: Douglas BACK, Buckeye Lake, OH (US)

(21) Appl. No.: 17/793,090

(22) PCT Filed: Jan. 27, 2021
(86) PCT No.: PCT/US2021/015180

§ 371 Date: Jul. 15, 2022

Related U.S. Application Data
(60) Provisional application No. 62/968,548, filed on Jan. 31, 2020.

(51) Int. Cl. B32B 3/14; B32B 7/12; B32B 9/04; B32B 15/18; B32B 9/00; B23K 1/19; B23P 15/28

(52) U.S. Cl. CPC B32B 3/14; B32B 7/12; B32B 9/041; B32B 15/18; B32B 9/007; B32B 9/04; B23K 1/19; B23P 15/28; B32B 2307/554; B32B 2603/00; B23K 2103/52

(57) ABSTRACT

A wear-protected substrate includes a substrate and a continuous wear protection layer brazed to the substrate. The continuous wear protection layer includes components having interlocking features that are configured to interlock the components side-by-side to form the continuous wear protection layer.

### TECHNICAL FIELD AND INDUSTRIAL APPLICABILITY

The present disclosure relates generally to surface structures formed of hard or super-hard materials, including, e.g., diamond, cubic boron nitride (cBN) and/or carbide based materials, that provide wear resistant properties and methods of making and using the same. Specifically, the present disclosure relates to the fabrication and subsequent arrangement of interlocking diamond, cBN and/or carbide based components to form a continuous and mechanically engaged layer providing wear resistance across a relatively large surface area of the underlying substrate.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

In the field of industrial manufacturing and assembly, there are many tools that are useful in the fabrication and assembly of products and systems. However, the intended use of certain tools can make the tools susceptible to wear and tear over time due to repeated engagement with production materials. Such tools include, without limitation, knives, cutters, and other edges that are designed to forcibly engage components or raw materials in order to cut, shear, slice, or otherwise separate a portion of material from the whole. As will be understood, such tools are especially susceptible to wear when engaging with hardened materials such as metals. Such tool wear can result in inefficiencies in a manufacturing process due to degrading performance of the tool over time and eventual stoppage of manufacturing processes to facilitate maintenance and/or replacement of such tools.

Such tools can be modified to include a wear-resistant material attached to the engagement edge (or cutting edge) of the tool. Such wear-resistant materials can protect the underlying substrate and limit overall wear of the tool over time; thus, forming a longer lasting tool that facilitates more efficient manufacturing processes. Certain known wear-resistant materials are good candidates for modification and improvement of the cutting edge of tools, including diamond based, cBN based and/or carbide based materials (e.g., polycrystalline diamond (PCD), diamond, diamond composites, silicon carbide (SiC)-diamond, cBN and the like). It will be understood that such wear-resistant materials are an improvement over tools that are already made from relatively tough and/or hardened materials such as metals or metal alloys (e.g., steel, Inconel alloys, superalloys, and the like) or composites (e.g., carbides).

While it is known that certain wear-resistant materials are good candidates for improving the cutting edges of tools, there are significant challenges with applying such wear-resistant materials to such tools. For example, prior art fabricating techniques make it very difficult to produce wear-resistant materials in one continuous section that could offer a substantial surface area for a cutting edge. Wear-resistant materials are formed in relatively small sizes and offer relatively limited surface areas. Thus, to cover any sizable cutting edge, it is required for a significant number of small wear-resistant pieces to be placed adjacent to one another in an attempt to assemble a sizable wear-resistant cutting edge.

One technique for assembling a number of small wear-resistant pieces into a sizable wear-resistant cutting edge is to use a brazing process to form a continuous wear-resistant cutting edge from a number of individual pieces abutted together. However, such a technique is problematic because complex fixturing is required to secure the pieces together in both lateral and vertical directions during heating and cooling cycles. If the fixturing is ineffective, the wear-resistant edge can include gaps and elevation difference between the various adjacent pieces that comprise the wear-resistant edge. As will be understood, such an arrangement forms and inferior or even ineffective cutting edge.

There is a need for tools and methods of making tools with wear-resistant edges that are efficiently manufactured and result in a smooth and even wear-resistant cutting edge. This disclosure describes such tools and methods of making such tools.

### SUMMARY

Provided herein is a description of a wear-protected substrate that includes a substrate with a continuous wear protection layer brazed to the substrate. The continuous wear protection layer includes components having interlocking features that are configured to interlock the components side-by-side to form the continuous wear protection layer.

Provided herein is a description of a method of forming a protected substrate. The method includes providing a plurality of components, each having interlocking features. Each of the plurality of components is formed of a wear resistant material such as one comprising or consisting of a hard or super-hard material including, for example, diamond, PCD, PCD on a carbide substrate, cBN, carbide. SiC-diamond, thermally stable diamond composite, or a combination thereof. The method includes providing a substrate and assembling and attaching the plurality of components to the substrate. The method also includes forming a continuous protection layer on the substrate.

Further provided herein is a description of a wear protection layer brazed to a substrate. The wear protection layer includes components having interlocking features that are configured to interlock the components side-by-side. The wear protection layer is continuous and substantially free of gaps and elevation variances between the components.

### BRIEF DESCRIPTION OF THE DRAWINGS

The foregoing summary, as well as the following detailed description of the embodiments, can be bettor understood when read in conjunction with the appended drawings. It should be understood that the embodiments depicted are not limited to the precise arrangements and instrumentalities shown.

FIG. 1 shows an exemplary perspective view of a protected substrate including a protection layer attached to a substrate;

FIG. 2 shows an exemplary protection layer including interlocked components that are attached to one another side-by-side; and

FIG. 3 shows an exemplary process of forming the protected substrate of FIG. 1.

### DETAILED DESCRIPTION

The disclosure relates to components providing wear protection and methods of making and using the same. Specifically, the present disclosure relates to an improved protection layer formed of interlocked wear protection components to protect relatively large surface areas.

In one example, a protection layer may be brazed to a substrate to provide wear resistance to the substrate. The protection layer may be formed of wear-resistant materials, such as one comprising or consisting of a hard or super-hard material including, e,g., diamond based, cBN based and/or carbide based materials (e.g., polycrystalline diamond (PCD), diamond, diamond composites, cBN, silicon carbide (SiC)-diamond, etc.). The protected material or substrate may be formed of metals or metal alloys (e.g., steel, Inconel alloys, superalloys, etc.) or composites (e.g., carbides). Due to the limitations in production capabilities, it may be difficult to produce a long or large continuous layer made of diamond based, cBN based and/or carbide based materials even when those materials are supported by carbides. The size (e.g., surface area) of the diamond based, cBN based and/or carbide based components may be limited by the size of the refractory equipment (e.g., a press for forming tiles or pellets) available to produce such components. For example, a common refractory press of typical size may produce diamond based, cBN based and/or carbide based components or tiles of no more than 58 millimeter (mm) in diameter. Without techniques to effectively assemble such components, the maximum surface area that can be protected using this particular single continuous component is insufficient for most uses.

Therefore, it is advantage to utilize efficient techniques for arranging components or tiles together to form a protection layer with a larger area. As noted earlier, the prior art techniques am challenging because gaps and elevation differences between adjacent tiles are likely to form due to relative movement between the components when attempting to secure the components to the substrate. Such gaps can form during heating and/or cooling cycles in a brazing process because of the differences between thermal expansion coefficients of the components and substrate materials. Any gaps between the wear-resistant components can potentially become a weak or wear spot, leading to premature failure in wear protection functionality.

With the foregoing in mind, the present disclosure is directed to interlocked wear protection components and method of making and using the same. In particular, the present disclosure describes methods of tightly assembling wear-resistant components or tiles into a continuous layer to protect a relatively large surface. An effective tool can be formed from wear-resistant tiles secured to a substrate. The wear-resistant tiles can be formed of diamond based, cBN based and/or carbide based materials, such as PCD, PCD on a carbide substrate, SiC-diamond, carbide, cBN, diamond, (thermally stable) diamond composites, or a combination thereof, and the substrate can be formed of metals or metal alloys (e.g., steel, Inconel alloys, superalloys, etc.) or composites (e.g., carbides). The wear-resistant components can be formed with interlocking features, such as, for example, dovetail features, mortises features, keyholes features, and other such features. The interlocking features can be mechanically engaged to secure the wear-resistant tiles together. Such an arrangement can statically position the tiles relative to one another and retain the general geometry of the assembled tiles during an attachment process (process of attaching the wear-resistant tiles to one another and/or brazing the wear-resistant components to the substrate). In particular, the interlocking features can enable an easy, precise, and scalable tile assembly to form a continuous protection layer on a substrate. The continuous protection layer can be formed to be substantially gap-free with a generally smooth outer surface (i.e., little or no elevation differences between adjacent tiles), where the assembly can be arranged in any suitable geometry and/or size.

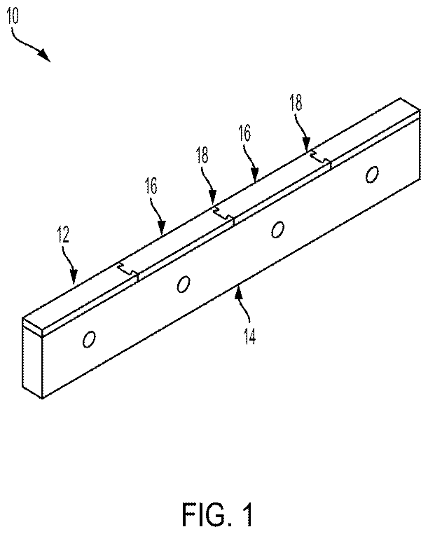

FIG. 1 illustrates an exemplary perspective view of a protected substrate 10 including a protection layer 12 attached to a substrate 14. The protection layer 12 can be attached to the substrate 14 via any suitable methods, such as brazing (e.g., furnace brazing, vacuum brazing, etc.). The substrate 14 can be formed of metals or metal alloys (e.g., steel, Inconel alloys, superalloys, etc.) or composites (e.g., carbides). The protection layer 12 includes components or tiles 16 that are interlocked using one or more interlocking features 18. The tiles 16 can have any shapes (e.g., rectangle, triangle, square, circle, irregular shapes, etc.) and sizes. The tiles 16 can have the same or different sizes or different sizes, and can have the same or different shapes. At least some if not all of the tiles 16 can include the interlocking features 18. The interlocking features 18 can be any suitable geometries and sizes to prevent relative movements of the interlocked tiles 16. For example, the interlocking features 18 may include, but are not limited to, dovetails, mortises, keyholes, or a combination thereof.

A protected substrate, such as the one shown in FIG. 1, can be used in any suitable application. For example, the protected substrate 10 can be used as a rotor or blade in a pelletizer such as the pelletizing system described in U.S. Pat. No. 7,393,201, incorporated herein in its entirety by reference. Likewise, similar protected substrates having any known shape and/or geometries can be used for additional applications, such as a surface in a down-hole drilling for a component such as, e.g., a valve, a valve seat, a bearing or other wearable surface.

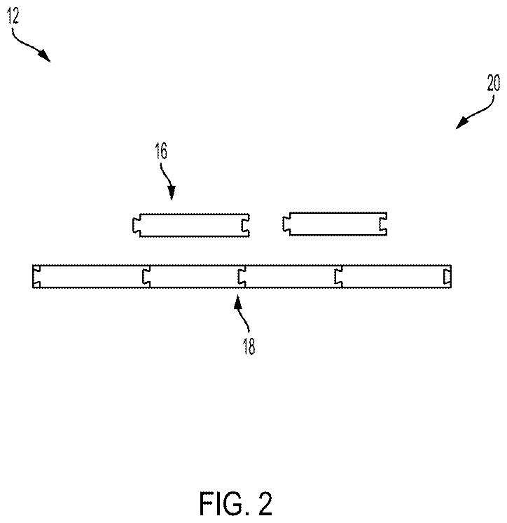

As shown in FIG. 2, the tiles 16 can be assembled or attached to one another side-by-side (e.g., along the lateral edges) using the interlocking features 18 to form the protection layer 12. The tiles 16 can have an interlocking feature 18 on any of its sides or lateral edges (e.g., on one or more of the four sides or a rectangular tile, on one or more of the three sides of a triangular title, etc.). The area 20 of the protection layer 12 depends on the number tiles 16 and size of each tile 16, and the total area 20 is scalable based on the number of tiles 16 and size of each tile 16 selected. The tiles 16 can be arranged or assembled to form the protection layer 12 arranged in any shape (e.g., rectangle, triangle, square, circle, irregular shapes, etc.) or size. The tiles 16 can be attached to one another (e.g., along the interlocking features 18 and/or along any sides or lateral edges) using any suitable methods, such as brazing (e.g., furnace brazing, vacuum brazing, etc.), gluing, shrink fitting, tight fitting, tight interfacing, epoxying, or a combination thereof. The titles 16 can be glued with any adhesive (e.g., glue, epoxy, etc.) or brazed with a brazing foil formed of any suitable brazing alloys (e.g., ticusil, incusil, etc.).

The tiles 16 can also be formed of wear-resistant and thermally stable diamond composite, such as VERSIMAX® diamond composite produced by Hyperion Materials and Technologies. VERSIMAX® includes, by weight, about 90% diamond grains, about 9% silicon carbide bonded to the diamond grains and about 1% unreacted silicon metal. VERSIMAX® is thermally stable at temperatures of up to 1400° C. Other thermally stable ceramic-bonded diamond composite materials may also be used for the bearing element material. For example, a thermally stable material may comprise or consist of, by weight, about 50 to about 96% diamond grains, about 3 to about 49% silicon carbide, and about 0.1 to about 10% unreacted silicon metal. The ceramic-bonded diamond material may also comprise or consist of, by weight, about 50-99% diamond grains, 1-25% silicon carbide bonded to the diamond grains and 0.01-5% unreacted silicon metal.

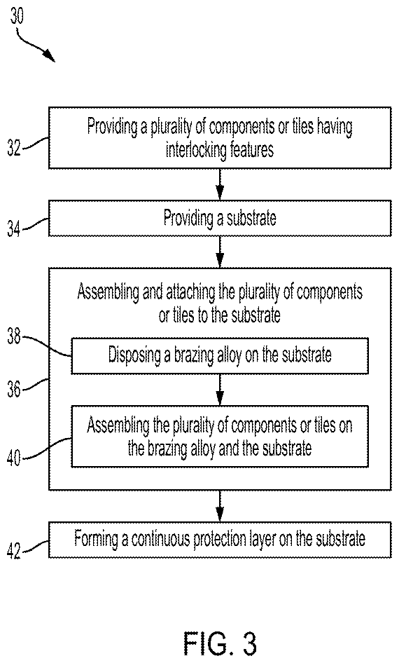

FIG. 3 depicts an exemplary process 30 of forming the protected substrate 10. The exemplary process 30 includes providing a plurality of tiles 16 having interlocking features 18 (step 32). Step 32 can include producing a plurality of tiles 16 using a refractory press and mold configured to produce the tiles 16 in a desired shape and size and including one or more interlocking features 18. The interlocking features 18 can be any suitable geometries and sizes to prevent relative movements of the interlocked tiles 16. As previously noted, the interlocking features 18 can be dovetails, mortises, keyholes, or a combination thereof. However, such features are not limited to this recited list. It will be understood that any feature that effectuates an interlocking of adjacent tiles 16 to prevent relative movement of these adjacent tiles 16 is included in this disclosure.

Step 32 can include producing or obtaining blanks made of the wear-resistant materials set forth above and cutting the blanks into tiles 16 of desired shapes and sizes and including the desired interlocking features 18.

The process 30 can further include providing a substrate (step 34). Step 34 can include obtaining or fabricating a suitable substrate. The substrate 14 can serve as a base for a tool, such as a knife or other cutter, where the tiles 16 are secured to the substrate 14 to form the wear-resistant cutting edge. The substrate 14 can be formed of metals or metal alloys (e.g., Steel, Inconel alloys, superalloys, etc.) or composites (e.g., carbides).

The process 30 can include assembling and attaching the plurality of tiles 16 to the substrate 14 (step 36). Step 36 can include disposing a brazing alloy on the substrate 14 (step 38). The brazing alloy can be in any suitable form, such as a foil or sheet. The brazing alloy can be any suitable brazing alloys, such as ticusil, incusil, etc. Step 36 can include assembling the plurality of tiles 16 on the brazing alloy and the substrate 14 (step 40). Step 40 can include assembling the tiles 16 in a side-by-side arrangement (e.g., along the lateral edges) using the interlocking features 18 to secure the tiles 16 together. Step 40 can also include attaching the tiles 16 in a side-by-side arrangement using interlocking features 18 and applying any suitable methods, such as brazing (e.g., furnace brazing, vacuum brazing, etc.), gluing, shrink fitting, tight fitting, tight interfacing, epoxying, or a combination thereof. Step 40 can further include disposing a brazing alloy along the butted edges of the directly adjacent tiles 16. The assembled tiles 16 are configured to cover a desired portion of any suitable sizes and shapes of the substrate 14. The assembled tiles 16 can be configured to cover at least a portion or the entire top surface of the substrate 14.

The process 30 can include forming a continuous protection layer on the substrate (step 42). Step 42 can include brazing (e.g., furnace brazing, vacuum brazing, etc.) the assembled tiles 16 (from step 40) on the substrate 14 to form a continues protection layer 12. Step 42 can including applying a weight on top of the assembled tiles 16 to force contact between the assembled tiles 16 and the substrate 14 when brazing the assembled tiles 16 on the substrate 14.

In steps 36 to 42, the presence and functionality of the interlocking features 18 can substantially reduce or eliminate relative movement and shifting of the tiles 16 when the features 18 of each tile 16 are engaged with features 18 of adjacent tiles 16 during heating and/or cooling cycles of the assembling process (e.g., furnace brazing, vacuum brazing, gluing, shrink fitting, tight fitting, tight interfacing, epoxying, or a combination thereof). The presence of the interlocking features 18 thus substantially reduce or eliminate gaps and/or elevation differences in the finished product (e.g., the substrate 14 protected by the attached protection layer 12, which is comprised of interlocking tiles 16) produced based on the process 30. The continuous protection layer 12 formed based on the process 30 is substantially gap-free and smooth and can provide improved wear protection to the substrate 14.

With the use of the interlocking features 18 disclosed herein, the application of lateral force, vertical force, or both, to hold the tiles 16 in place during a brazing process is not needed. Therefore, the present disclosure (e.g., the interlocking features 18 and the process 30) can also make it easier to setup or prepare the tiles 16 and substrate for the brazing process (e.g., setting up a fixture to hold the tiles and the substrate for the brazing process) and facilitate a more efficient process.

It should be appreciated that the present disclosure can be used to protect any suitable surfaces not only those substrates disclosed herein. For example, the protection layer 12 formed by the interlocked tiles 16 can be attached or disposed on any type of suitable surface using the process 30 to protect such surface.

Unless defined otherwise all technical and scientific terms used herein have the same meaning as commonly understood to one of ordinary skill in the art to which the presently described subject matter pertains. Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a,” “an” and “at least one” are used interchangeably in this application.

Unless otherwise indicated, all numbers expressing quantities of ingredients, properties such as size, weight, reaction conditions and so forth used in the specification and claims are to the understood as being modified in all instances by the term “about”. As throughout the application, the term “about” may mean plus or minus 10% of the numerical value of the number with which it is being used; therefore, about 50% may mean in the range of 45%-55%. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

Throughout the application, descriptions of various embodiments use “comprising” language; however, it will be understood by one of skill in the art, that in some instances, an embodiment can alternatively be described using the language “consisting essentially of or “consisting of.”

All patent applications, patents, and printed publications cited herein are incorporated herein by reference in the entireties, except for any definitions, subject mailer disclaimers or disavowals, and except to the extent that the incorporated material is inconsistent with the express disclosure herein, in which case the language in this disclosure controls.

While reference has been made to specific embodiments, it is apparent that other embodiments and variations can be devised by others skilled in the art without departing from their spirit and scope. The appended claims are intended to be construed to include all such embodiments and equivalent variations.

1. A wear-protected substrate, comprising:
a substrate; and
a continuous wear protection layer brazed to the substrate, wherein the continuous wear protection layer comprises components having interlocking features that are configured to interlock the components side-by-side to form the continuous wear protection layer.

2. The wear-protected substrate of claim 1, wherein the interlocking features comprise dovetail, mortises, keyholes, or a combination thereof.

3. The wear-protected substrate of claim 1, wherein the components are attached to one another via one or more methods comprising brazing, gluing, shrink fitting, tight fitting, tight interfacing, epoxying, or a combination thereof.

4. The wear-protected substrate of claim 3, wherein the components are attached to one another via brazing, and a brazing alloy is disposed along the interlocking features and between the components.

5. The wear-protected substrate of claim 1, wherein the components are formed of diamond, polycrystalline diamond (PCD), PCD on a carbide substrate, carbide, cBN silicon carbide (SiC)-diamond, thermally stable diamond composite, or a combination thereof.

6. The wear-protected substrate of claim 1, wherein the substrate is formed of metal, metal alloy, steel, superalloy, Inconel alloy, or composite.

7. The wear-protected substrate of claim 1, wherein the area of the continuous wear-protection layer is scalable by increasing or decreasing the number of components.

8. The wear-protected substrate of claim 1, wherein the continuous wear-protection layer is substantially free of gaps between the components that are brazed to one another and/or brazed to the substrate.

9. The wear-protected substrate of claim 1, wherein the continuous wear protection layer is brazed to the substrate using a brazing alloy comprising ticusil, incusil, or a combination thereof.

10. A method of forming a protected substrate, comprising:
providing a plurality of components having interlocking features, wherein the plurality of components are formed of diamond, PCD, PCD on a carbide substrate, carbide, SiC-diamond, thermally stable diamond composite, or a combination thereof;
providing a substrate;
assembling and attaching the plurality of components to the substrate; and
forming a continuous protection layer on the substrate.

11. The method of claim 10, comprising disposing a brazing alloy on the substrate.

12. The method of claim 10, comprising assembling the plurality of components on the brazing alloy and the substrate.

13. The method of claim 10, comprising attaching the plurality of components side-by-side via one or more methods comprising brazing, gluing, shrink fitting, tight fitting, tight interfacing, epoxying, or a combination thereof.

14. The method of claim 10, comprising brazing the assembled components on the substrate.

15. A wear protection layer brazed to a substrate, wherein the wear protection layer comprises components having interlocking features that are configured to interlock the components side-by-side, and wherein the wear protection layer is continuous and substantially free of gaps between the components.

16. The wear protection layer of claim 15, wherein the interlocking features comprise dovetail, mortises, keyholes, or a combination thereof.

17. The wear protection layer of claim 15, wherein the components are formed of diamond, PCD, PCD on a carbide substrate, carbide, SiC-diamond, thermally stable diamond composite, or a combination thereof.

18. The wear protection layer of claim 15, wherein the components are attached to one another via one or more methods comprising brazing, gluing, shrink fitting, tight fitting, tight interfacing, epoxying, or a combination thereof.

19. The wear protection layer of claim 15, wherein the components are attached to one another via brazing, and a brazing alloy is disposed along the interlocking features and/or between the components.

20. The wear protection layer of claim 15, comprises a brazing alloy disposed between the components.
